(19) United States
(12) Patent Application Publication
(10) Pub. No.: US 2026/0051019 A1
(43) Pub. Date: Feb. 19, 2026

(54) IMPLICIT DEPTH ESTIMATION FOR LOW LEVEL PERCEPTION MODELS

(71) Applicant: QUALCOMM Incorporated, San Diego, CA (US)

(72) Inventors: Andreas Sjadin Hallstrand, Linköping (SE); Mattis Lorentzon, Vikingstad (SE)

(21) Appl. No.: 18/808,352

(22) Filed: Aug. 19, 2024

(51) Int. Cl. G06T 3/04; G06T 7/50

(52) U.S. Cl. CPC G06T 3/04; G06T 7/50; G06T 2207/20081; G06T 2207/20084

(57) ABSTRACT

An apparatus includes a memory and processing circuitry in communication with the memory. The processing circuitry is configured to train a neural network. Processing circuitry may generate, using a first AI model, a birds-eye-view (BEV) representation from one or more sensor inputs, the BEV representation including BEV features and depth probability distributions. According to such an example, the processing circuitry is also configured to calculate a first loss for the depth probability distributions using a regularizing loss function. The processing circuitry may further be configured to process, using a second AI model, the BEV representation to generate an output and calculate a second loss using the output and ground truth. In at least one example, the processing circuitry is also configured to update parameters of the first AI model based on the first loss and the second loss.

### TECHNICAL FIELD

This disclosure relates to sensor systems, including techniques for training perception models.

### BACKGROUND

An autonomous driving vehicle is a vehicle that is configured to sense the environment around the vehicle, such as the existence and location of other objects, and to operate without human control. An autonomous driving vehicle may include cameras that produce image data that may be analyzed to determine the existence and location of other objects around the autonomous driving vehicle. A vehicle having advanced driver-assistance systems (ADAS) is a vehicle that includes systems which may assist a driver in operating the vehicle, such as parking or driving the vehicle.

### SUMMARY

The present disclosure generally relates to techniques and devices for improving depth estimation to objects in the context of computer vision. For instance, object detection utilizing low level perception (LLP) convolution neural network (CNN) models may utilize implicit depth estimation techniques in support of a variety of computer vision tasks. Such computer vision tasks may include performing view transformations from a two-dimensional perspective into a three-dimensional Bird's-Eye-View (BEV) representation, and performing one or more detection tasks on the BEV representation, such as object detection, image segmentation, path planning, and velocity detection, among others. Aspects of this disclosure include training a neural network of an Artificial intelligence (AI) model to generate “smoother” (e.g., reduced variability) depth estimate distributions for objects determined within sensor inputs (e.g., such as an object detected within a camera image), thus providing more realistic depth probabilities and providing a better estimate of distance from a source location to an obstacle within the image data. For example, in the context of ADAS systems, smoother depth estimate distributions yield more accurate depths (e.g., distances) between a vehicle at the source of the sensor inputs and an object detected within the sensor inputs. The higher accuracy thus correlates to better alignment with real-world distances between an actual vehicle and a physical object in the real world.

In the absence of large amounts of depth ground truth information upon which to train AI models to learn generalized parameters for determining depth estimations, aspects of the techniques of this disclosure reduce high variability associated with implicit depth estimation through application of a depth estimate guiding loss calculated utilizing regularizing loss function applied to a depth tensor. The regularizing loss function substitutes for depth ground truth when determining loss for the depth probabilities. For instance, a computer vision model may be trained to guide depth estimates on the assumption that a reasonable probability distribution for a depth estimate to any object should smoothly rise to a peak and smoothly fall back toward a baseline without high-frequency narrow spikes, which would typically be unlikely in real-world scenarios. The computer vision model may be further refined by weighting the depth related losses based on total variation of the estimated depth probabilities and adding the weighted total variation to a total model loss to guide implicit depth estimation toward a locally smoother slope along a depth axis of a respective estimated depth probability distribution. Through the application of back-propagation, a neural network of an AI model may be iteratively provided with updated parameters based on the depth related losses and the total model losses over a satisfactory number of training epochs until the AI model reaches convergence.

In one example, an apparatus includes a memory and processing circuitry in communication with the memory. The apparatus may be configured to train a neural network. According to one example, the processing circuitry of the apparatus is configured to generate, using a first AI model, a birds-eye-view (BEV) representation from one or more sensor inputs. In such an example, the BEV representation includes BEV features and depth probability distributions. According to such an example, the processing circuitry may be configured to calculate a first loss for the depth probability distributions using a regularizing loss function. Processing circuitry of the apparatus may also be configured to process, using a second AI model, the BEV representation to generate an output and calculate a second loss using the output and ground truth. According to at least one example, processing circuitry may be configured to update parameters of the first AI model based on the first loss and the second loss.

In another example, a method for training a neural network includes generating, using a first AI model, a birds-eye-view (BEV) representation from one or more sensor inputs. In such an example, the BEV representation includes BEV features and depth probability distributions. The method may also include calculating a first loss for the depth probability distributions using a regularizing loss function. According to at least one example, the method includes processing, using a second AI model, the BEV representation to generate an output and calculating a second loss using the output and ground truth. The method may also include updating parameters of the first AI model based on the first loss and the second loss.

In another example, a non-transitory computer-readable medium stores instructions that, when executed, cause processing circuitry to: generate, using a first AI model, a birds-eye-view (BEV) representation from one or more sensor inputs, in which the BEV representation includes BEV features and depth probability distributions. According to at least one example, the processing circuitry may calculate a first loss for the depth probability distributions using a regularizing loss function. In certain examples, the instructions, when executed, cause the processing circuitry to process, using a second AI model, the BEV representation to generate an output and calculate a second loss using the output and ground truth. The instructions may also cause the processing circuitry to update parameters of the first AI model based on the first loss and the second loss.

In another example, an apparatus includes means for training a neural network. For instance, the apparatus may include means for generating, using a first AI model, a birds-eye-view (BEV) representation from one or more sensor inputs. In such an example, the BEV representation includes BEV features and depth probability distributions. The apparatus may also include means for calculating a first loss for the depth probability distributions using a regularizing loss function. According to at least one example, the apparatus includes means for processing, using a second AI model, the BEV representation to generate an output and means for calculating a second loss using the output and ground truth. The apparatus may also include means for updating parameters of the first AI model based on the first loss and the second loss.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example processing system, in accordance with one or more techniques of this disclosure.

FIG. 2 depicts a flow diagram for generating updated parameters to be applied using back-propagation, in accordance with one or more techniques of this disclosure.

FIG. 3 is a flow diagram for back-propagating updated model parameters to an updated view transform network, in accordance with one or more techniques of this disclosure.

FIG. 4 provides an example of regularizing loss calculating algorithm, in accordance with one or more techniques of this disclosure.

FIG. 5 is a flow diagram illustrating an example method for training perception models substituting a regularizing loss function for depth ground truth, in accordance with one or more techniques of this disclosure.

### DETAILED DESCRIPTION

Camera systems may be used in various different robotic, vehicular, and virtual reality (VR) applications. One such vehicular application is an advanced driver assistance system (ADAS). ADAS may be a system that uses camera technology to improve driving safety, comfort, and overall vehicle performance.

In some examples, the camera-based system is responsible for capturing high-resolution images and processing them in real time. The output images of such a camera-based system may be used in applications such as depth estimation, object detection, and/or pose detection, including the detection and recognition of objects, such as other vehicles, pedestrians, traffic signs, and lane markings. Cameras may be used in vehicular, robotic, and VR applications as sources of information that may be used to determine the location, pose, and potential actions of physical objects in the outside world.

The present disclosure generally relates to techniques and devices for improving depth estimation to objects in the context of computer vision. For instance, object detection utilizing low level perception (LLP) convolution neural network (CNN) models may utilize implicit depth estimation techniques in support of a variety of computer vision tasks. Such computer vision tasks may include performing view transformations from a two-dimensional perspective into a three-dimensional Bird's-Eye-View (BEV) representation, and performing one or more detection tasks on the BEV representation, such as object detection, image segmentation, path planning, and velocity detection, among others. Aspects of this disclosure include training a neural network of an Artificial intelligence (AI) model to generate “smoother” (e.g., reduced variability) depth estimate distributions for objects determined within sensor inputs (e.g., such as an object detected within a camera image), thus providing more realistic depth probabilities and providing a better estimate of distance from a source location to an obstacle within the image data. For example, in the context of ADAS systems, smoother depth estimate distributions yield more accurate depths (e.g., distances) between a vehicle at the source of the sensor inputs and an object detected within the sensor inputs. The higher accuracy thus correlates to better alignment with real-world distances between an actual vehicle and a physical object in the real world.

In the absence of large amounts of depth ground truth information upon which to train AI models to learn generalized parameters for determining depth estimations, aspects of the techniques of this disclosure reduce high variability associated with implicit depth estimation through application of a depth estimate guiding loss utilizing a regularizing loss function designed based on physics constraints. The regularizing loss function substitutes for depth ground truth when determining a loss function for the depth probabilities. For instance, a computer vision model may be trained to guide depth estimates on the assumption that a reasonable probability distribution for a depth estimate to any object should smoothly rise to a peak and smoothly fall back toward a baseline without high-frequency narrow spikes, which would typically be unlikely in real-world scenarios. The computer vision model may be further refined by weighting the depth related losses based on total variation of the estimated depth probabilities and adding the weighted total variation to a total model loss to guide implicit depth estimation toward a locally smoother slope along a depth axis of a respective estimated depth probability distribution. Through the application of back-propagation, a neural network of an AI model may be iteratively provided with updated parameters based on the depth related losses and the total model losses over a satisfactory number of training epochs until the AI model reaches convergence.

Techniques of this disclosure may improve upon depth estimations provided by existing models trained to convergence to recognize objects from sensor inputs of a vehicle ADAS system. For example, a system trained to convergence for performing lane detection may satisfactorily recognize lane markers in a training dataset, and yet, may exhibit unsatisfactory generalization across larger training domains or generate unsatisfactory predictive output at inference due to poor generalization. Stated differently, a trained AI model may nevertheless fail to accurately estimate distances to certain objects, such as lane markers, despite attaining convergence or satisfying other training criteria. The poor generalization may be due to noise in the sensor data obtained at inference, noise in the training data, a lack of sufficient training data with ground truth, overfitting, or some combination thereof. Overfitting may occur when a trained model learns not only underlying patterns from the training data but also captures noise and random fluctuations that are specific to the training dataset resulting in a model that performs well on the training data but fails to generalize to unseen test data or real-world data.

Model generalization may be improved by smoothing out high variability depth probability distributions generated through the application of implicit depth perception. In the context of machine learning and computer vision, implicit depth perception refers to the capability of an AI model to infer or estimate depth information from visual data without explicit supervision or labeled depth maps with ground truth information. AI models trained to perform depth estimation may be trained on large datasets where images are paired with depth maps or other ground truth depth information. However, no such ground-truth information is available when a trained AI model is operating in-situ (e.g., at model inference processing previously unseen real-world data) and training datasets may lack sufficient depth ground-truth information upon which to attain satisfactory generalization to large information domains, such as widely varying real-world environments.

Generating smoother depth probability distributions may improve downstream tasks that operate on the predictions and output provided by trained AI models, including trained BEV grid networks which provide output to facilitate computer vision tasks including assisted and autonomous control of a vehicle.

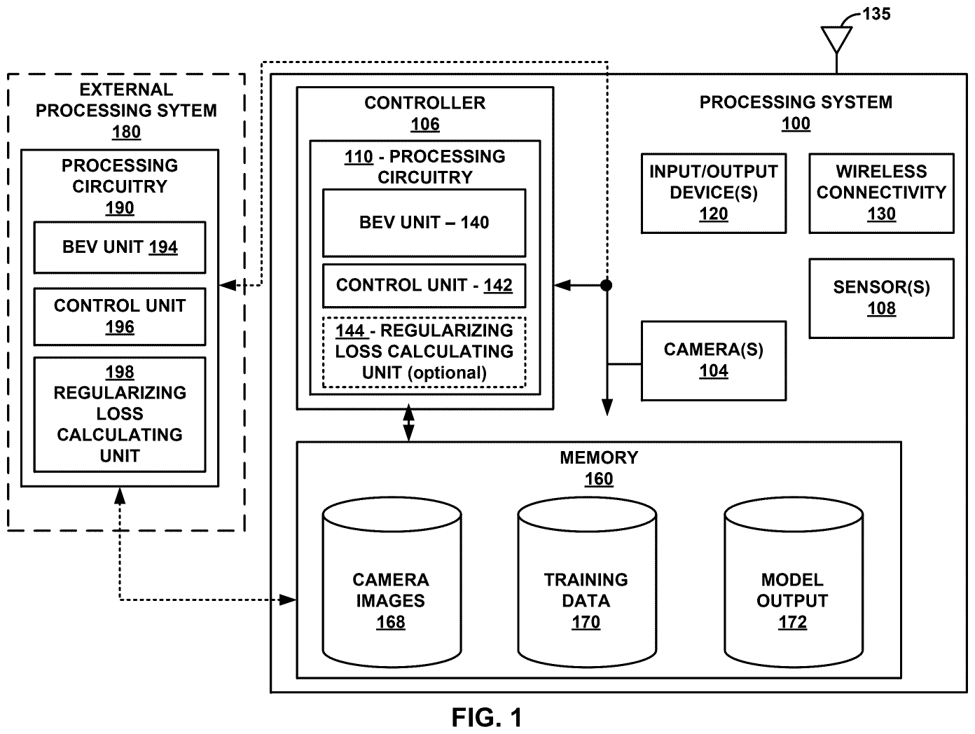

FIG. 1 is a block diagram illustrating an example processing system, in accordance with one or more techniques of this disclosure. Processing system 100 may be used in an apparatus, such as a vehicle, including an autonomous driving vehicle or an assisted driving vehicle (e.g., a vehicle having an advanced driver-assistance system (ADAS) or an “ego vehicle”). In such an example, processing system 100 may represent an ADAS. In other examples, processing system 100 may be used in robotic applications, virtual reality (VR) applications, or other kinds of applications that may include both a camera and a LiDAR system. The techniques of this disclosure are not limited to vehicular applications. The techniques of this disclosure may be applied by any system that processes image data and/or position data.

According to certain examples, processing system 100 does not include regularizing loss calculating unit 144 which is depicted as an optional component of FIG. 1. For example, BEV unit 140 of processing system 100 may be trained on external processing system 180 using BEV unit 194 and regularizing loss calculating unit 198 of external processing system 180 to update BEV model 140, providing an updated variant of BEV model 140 (e.g., a trained AI model) as an output of external processing system 180. Subsequently, processing system 100 may utilize the updated variant of BEV unit 140 as a trained AI model to control a vehicle. Stated differently, external processing system 180 may offload responsibility for training BEV unit 140 for subsequent use by processing system 100 within a vehicle. In other examples, processing system 100 may utilize BEV unit 140 along with the optionally provided regularizing loss calculating unit 144 generate the trained variant of BEV unit 140 for use as a trained AI model to control a vehicle.

Processing system 100 may include camera(s) 104, controller 106, one or more sensor(s) 108, input/output device(s) 120, wireless connectivity component 130, and memory 160. Camera(s) 104 may be any type of camera configured to capture or obtain sensor inputs, video, camera images, and/or image data from the environment around processing system 100 (e.g., around a vehicle). In some examples, processing system 100 may include multiple cameras 104 each of which are independently capable of generating sensor inputs. For example, camera(s) 104 may include a front-facing camera (e.g., a front bumper camera, a front windshield camera, and/or a dashcam), a back-facing camera (e.g., a backup camera), side-facing cameras (e.g., cameras mounted in sideview mirrors). Camera(s) 104 may be a color camera or a grayscale camera. In some examples, camera(s) 104 may be a camera system including more than one camera sensor. Camera(s) 104 may, in some examples, be configured to collect camera images 168 (e.g., sensor inputs).

Wireless connectivity component 130 may include subcomponents, for example, for third generation (3G) connectivity, fourth generation (4G) connectivity (e.g., 4G Long Term Evolution (LTE)), fifth generation (5G) connectivity (e.g., 5G or New Radio (NR)), Wi-Fi connectivity, Bluetooth connectivity, and other wireless data transmission standards. Wireless connectivity component 130 is further connected to one or more antennas 135.

Processing system 100 may also include one or more input and/or output devices 120, such as screens, touch-sensitive surfaces (including touch-sensitive displays), physical buttons, speakers, microphones, and the like. Input/output device(s) 120 (e.g., which may include an I/O controller) may manage input and output signals for processing system 100. In some cases, input/output device(s) 120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processing circuitry 110). In some cases, a user may interact with a device via input/output device(s) 120 or via hardware components controlled by input/output device(s) 120.

Controller 106 may be an autonomous or assisted driving controller (e.g., an ADAS) configured to control operation of processing system 100 (e.g., including the operation of a vehicle). For example, controller 106 may control acceleration, braking, and/or navigation of a vehicle through the environment surrounding the vehicle. Controller 106 may include one or more processors, e.g., processing circuitry 110. Controller 106 is not limited to controlling vehicles. Controller 106 may additionally or alternatively control any kind of controllable object, such as a robotic component. Processing circuitry 110 may include one or more central processing units (CPUs), such as single-core or multi-core CPUs, graphics processing units (GPUs), digital signal processor (DSPs), application specific integrated circuits (ASICs), field programmable gate arrays (FPGAs), neural processing unit (NPUs), multimedia processing units, and/or the like. Instructions applied by processing circuitry 110 may be loaded, for example, from memory 160 and may cause processing circuitry 110 to perform the operations attributed to processor(s) in this disclosure. In some examples, one or more of processing circuitry 110 may be based on an Advanced Reduced Instruction Set Computer (RISC) Machine (ARM) or a RISC five (RISC-V) instruction set.

An NPU is generally a specialized circuit configured for implementing control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processing circuitry 110 may also include one or more sensor processing units associated with camera(s) 104, and/or sensor(s) 108. For example, processing circuitry 110 may include one or more image signal processors associated with camera(s) 104 and/or sensor(s) 108, and/or a navigation processor associated with sensor(s) 108, which may include satellite-based positioning system components (e.g., Global Positioning System (GPS) or Global Navigation Satellite System (GLONASS)) as well as inertial positioning system components. In some aspects, sensor(s) 108 may include direct depth sensing sensors, which may function to determine a depth of or distance to objects within the environment surrounding processing system 100 (e.g., surrounding a vehicle).

Processing system 100 also includes memory 160, which is representative of one or more static and/or dynamic memories, such as a dynamic random-access memory, a flash-based static memory, and the like. In this example, memory 160 includes computer-executable components, which may be applied by one or more of the aforementioned components of processing system 100.

Examples of memory 160 include random access memory (RAM), read-only memory (ROM), electrically erasable programmable ROM (EEPROM), compact disk ROM (CD-ROM), or another kind of hard disk. Examples of memory 160 include solid state memory and a hard disk drive. In some examples, memory 160 is used to store computer-readable, computer-executable software including instructions that, when applied, cause a processor to perform various functions described herein. In some cases, memory 160 contains, among other things, a basic input/output system (BIOS) which controls basic hardware or software operation such as the interaction with peripheral components or devices. In some cases, a memory controller operates memory cells. For example, the memory controller may include a row decoder, column decoder, or both. In some cases, memory cells within memory 160 store information in the form of a logical state.

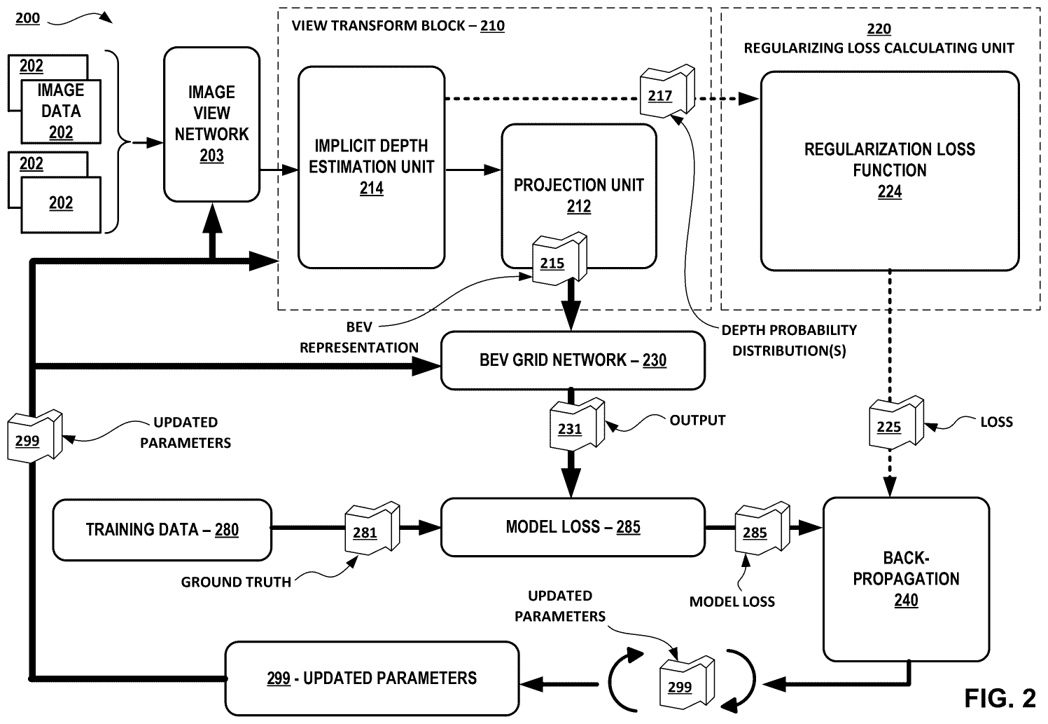

Processing system 100 may be configured to perform techniques for obtaining sensor inputs and image data, including camera images 168 from camera(s) 104 of processing system 100 and extracting camera features from the sensor inputs, image data, and position data. In certain examples, processing system 100 is configured to process the camera features, fuse the features, project the camera features into BEV image space utilizing BEV unit 140 having been trained on BEV unit 194 of external processing system. In other examples, processing system 100 is configured to process the camera features, fuse the features, project the camera features into BEV image space, generate depth losses using a regularizing loss function as a substitute for ground truth and model losses using output from BEV unit 140 and ground truth information, and train BEV unit 140 as an AI model (e.g., see view transform block 210 of FIG. 2) to generate smoother depth estimate probability distributions by back-propagating updated parameters based on the calculated losses to the various AI models. BEV unit 140 may be implemented in software, firmware, and/or any combination of hardware described herein. BEV unit 140 may be configured to receive or obtain sensor inputs and camera images 168 captured by camera(s) 104. BEV unit 140 may be configured to receive sensor inputs and camera images 168 directly from camera(s) 104, or from memory 160. In some examples, sensor inputs and/or camera images 168 may be referred to herein as “image data.” Moreover, sensor inputs and camera images 168 may include static images, video imagery, a video stream, LiDAR data, radar data, GPS data, or some combination thereof.

In general, BEV unit 140 may apply any of a variety of image transformation operations to generate Bird's Eye View (BEV) features from cameras. For instance, one technique includes application of Lift, Splat, Shoot (LSS) to generate the BEV features from cameras which may be projected into (e.g., fused) BEV space using known camera geometry. As discussed below, BEV unit 140 may generate BEV images based on image data captured by multiple cameras (e.g., a two-dimensional (2D) images) in a manner that produces less data and thus reduces processor burdens, external data transfer delays, and power usage.

Lift, Splat, Shoot (LSS) may generate estimated depth distributions based on camera features generated from sensor inputs and/or camera images 168. In a lift stage, features in each image may be “lifted” from a local 2-dimensional coordinate system to a 3-dimensional (3D) frame that is shared across all cameras. The lift process is repeated for each camera of a multi-camera system (e.g., camera(s) 104). The splat process of LSS is then performed for all of the lifted images into a single representation (e.g., the BEV representation).

To accurately determine a 3D frame, depth information is used but the “depth” associated with each pixel is ambiguous. A Lift, Splat, Shoot operation may utilize representations at many possible depths for each camera feature location (e.g., each pixel of a projected ray) using a depth vector. The depth vector, or depth distribution, may be predicted by a machine learning model, such as a deep neural net (DNN). The depth distribution may be learnt using supervised depth or as a latent representation. Back-propagation may be applied to iteratively update parameters of the machine learning model over its multiple training epochs to train the machine learning model to generate smoother depth probability distributions.

The depth vector is a plurality of depth estimate values along a ray from the camera center to a pixel in the image, where each value represents the probability that the pixel in the image is at a particular depth. Because the values of the depth vector are probabilities, the total of the values in the depth vector may add up to 1. In other examples, the total of the values in the depth vector will sum to a value greater than 0 but less than 1. The depth vector may be any length (e.g., number of possible depth values). The longer the depth vector, the more granular the depth values that may be detected, but at the cost of a larger data size. In one example, the depth vector length is 128, but other depth vector lengths may be used.

A context vector of camera features (also called a feature vector) may be constructed using a machine learning model for each pixel. The context vector may be related to attention and may indicate different possible identities or classifications for a pixel. The context vector includes a plurality of values that indicate the probability that a particular pixel represents a particular feature. That is, each value in the context vector may represent a different possible feature. For autonomous driving, features may be used to detect certain types of objects, including cars, trucks, bikes, pedestrians, signs, bridges, road markings, curbs, or other physical objects in the world that may be used to make autonomous driving decisions. The number of values in the context vector is indicative of the number of features that are to be detected in the image. One example context vector length is 80, but more or fewer features may be detected depending on the use case.

To perform the lift process, BEV unit 140 may be configured to combine the depth vector and the context vector using an outer product operation. For a depth vector length (D_{size}) of 128 and a context vector length (C_{size}) of 80, this combination results in a large expansion of layer output volume (frustum_volume) as the layer output volume is proportional to the number of cameras (num_cameras), the image size (represented by image_width and image _height), the length of the depth vector (D_{size}), and the length of the context vector (C_{size}), as shown below: frustum_volume=num_cameras*(image_width/8)*(image_height/8)*D_{size}*C_{size}. While division by 8 is utilized in this particular example, a different divisor may be utilized, depending on the resolution on which the view transform is performed.

In accordance with the techniques of this disclosure, BEV unit 140 may project camera features into a BEV image space resulting in a BEV representation having BEV features corresponding to high variability estimated depth probability distributions. In the context of computer vision, and specifically when performing camera perception tasks, an image transform operation projects camera features out along rays into a representation of the real-world utilizing distinct depth values represented by the term “D”, with each of the distinct depth values (D) being assigned a corresponding estimated depth probability resulting in a distribution. As noted above, the sum of the locations yields a distribution which adds up to a value of “1”. The depth estimate distribution may be considered highly variable when the values in the depth estimate distribution are widely spread out or dispersed from the central tendency (mean, median, mode) of the distribution. Variability is a measure of how much the values in a dataset differ from each other and from the average value. Conversely, a smooth depth estimate distribution occurs when the values of the depth estimate distribution are relatively evenly spread out across the range of values, without significant gaps, abrupt changes, or irregularities.

High variability in the depth estimate distribution may reduce generalization capabilities of trained AI models to unseen image domains including real-world sensor input and image data captured by a vehicle. Therefore, in accordance with aspects of the disclosure, processing circuitry 110 may further include regularizing loss calculating unit 144 which enables a neural network of an AI model to be trained to generate smoother depth estimate distributions. The smoother depth estimate distributions may improve AI model generalization to unseen sensor inputs, image data, and information domains. Additionally, AI models trained to generate smoother depth estimate distributions using regularizing loss calculating unit 144 may improve operation of downstream tasks that operate on output provided by BEV unit 140, including, for example, performing assisted and autonomous driving tasks for a vehicle with less latency, greater accuracy, reduced memory consumption, reduced computational load, or some combination thereof.

According to at least one aspect of the disclosure, BEV unit 140 is an AI model trained using back-propagation iteratively updating parameters of the AI model over multiple training epochs. In such an example, a high variability depth estimate distribution may be smoothed using a regularizing loss function. For example, regularizing loss calculating unit 144 may apply a regularizing loss function to reduce variability of an AI generated depth estimate distribution. For instance, a depth estimation tensor may be added as another output from a neural network with the regularization loss function designed to guide the depth estimation toward a smoother distribution. Such a regularizing loss function may calculate a total variation of the AI generated depth estimate distribution and weight the total variation by the calculated loss. The total variation function is differentiable and may help to guide an implicit depth estimation function to be locally smoother along the depth axis for each discretized location corresponding to the sensor inputs or an image view encoder feature map.

Total model loss (e.g., a second loss distinct from the depth related loss calculated utilizing regularizing loss function) may be calculated for a BEV representation. The total model loss may be calculated based on a difference between an AI generated output and ground truth information (e.g., such as that provided by training data 170).

Regularizing loss calculating unit 144 may calculate a depth-based loss using a regularizing loss function as a separate loss distinct from a model loss. The depth-based loss and model loss may be back-propagated to BEV unit 140 during training using updated parameters. The depth-based loss and model loss may be iteratively re-calculated until the AI model satisfies a threshold number of training epochs, until the AI model reaches convergence, or until the AI model attains some training termination threshold, such as one or both losses satisfying a configurable threshold.

Regularizing loss calculating unit 144 may calculate a loss without reference to ground truth information by pulling the depth tensor and applying a regularizing loss function. The regularizing loss function may be designed based on physics-based assumptions and/or physics constraints. The regularizing loss function may be derived from various manually curated assumptions, or obtained from AI generated parameters. For example, for a given object determined within an environmental scene corresponding to a BEV representation, it may be reasonable to assume that depth values along a depth axis of a depth probability distribution should smoothly follow one another up a slope to a peak and back down to a baseline as would occur in a real-world environment without high variability along the depth slope which may be indicative of noise or over-fitting.

By updating an AI model to generate smoother depth estimate distributions from sensor input and/or camera image 168 data using a regularizing loss function, a machine learning model may apply available convolution capacity to the building of abstract features resulting in improved predictive output, such as more accurate object detection, more accurate depth estimation, and an overall improved model representation of the real-world environment within which a vehicle is operating.

In some examples, processing circuitry 110 may be configured to train one or more machine learning models such as encoders, decoders, positional encoding models, or any combination thereof applied by BEV unit 140 using training data 170. For example, training data 170 may include one or more training camera images along with ground truth data. Training data 170 may additionally or alternatively include features known to accurately represent one or more point cloud frames and/or features known to accurately represent one or more camera images. This may allow processing circuitry 110 to train an encoder to generate features that accurately represent camera images.

Processing circuitry 110 of controller 106 may apply control unit 142 to control, based on the generated BEV image, an object (e.g., a vehicle, a robotic arm, or another object that is controllable based on the output from BEV unit 140) corresponding to processing system 100. Control unit 142 may control the object based on information included in the output generated by BEV unit 140 relating to one or more objects within a 3D space including processing system 100. For example, the output generated by BEV unit 140 may include BEV images, an identity of one or more objects, a position of one or more objects relative to the processing system 100, characteristics of movement (e.g., speed, acceleration) of one or more objects, or any combination thereof. Based on this information, control unit 142 may control the object corresponding to processing system 100. The output from BEV unit 140 may be stored in memory 160 as model output 172.

As discussed above, aspects of the techniques of this disclosure may be performed by external processing system 180. That is, encoding input data, transforming features into BEV images, (including depth and context vector generation, depth distribution, depth probability estimation, calculating regularizing losses for depth estimate distributions, back-propagation, and other features) may be performed by a processing system that does not include the various sensors shown for processing system 100. Such a process may be referred to as “offline” data processing, where the output is determined from sensor inputs and/or camera images received from processing system 100. In some examples, external processing system 180 updates an AI model to generate smoother depth estimate distributions through the application of back-propagation in the manner described above and provides an updated variant of BEV unit 140 (e.g., a trained AI model) to processing system 100 (e.g., an ADAS or vehicle). Similarly, external processing system 180 may process sensor inputs and/or camera images 168 at inference time using BEV unit 194 and send output to processing system 100, for instance, to control a vehicle via an ADAS system).

While regularizing loss calculating unit 144 is depicted as part of processing circuitry 110 for controller 106, regularizing loss calculating unit 198 may optionally be included within processing circuitry 190 for external processing system 180. For instance, regularizing loss calculating unit 198 may be included within external processing system 180 for computer vision operations which are less time-sensitive, more computationally burdensome, or generally more resilient to operational latencies. In other examples, regularizing loss calculating units 144 and 198 are included in both processing circuitry 110 of controller 106 and also within external processing system 180 respectively, thus enabling certain computer vision tasks to be performed offline, off-loaded into the cloud, and/or performed by other remote external processing system 180 with low-latency operations being performed locally by processing system 100. For instance, in some implementations, generating a pre-trained AI model may be performed exclusively off-line by external processing system 180 with the pre-trained AI model provisioned to processing system 100 (e.g., downloaded and installed into a vehicle) for processing sensor inputs and/or camera images 168 in-situ during inference operations by the pre-trained AI model.

AI model inference is the process of applying a previously trained AI model to input data, such as sensor inputs and/or camera images 168, to make predictions, decisions, or generate output for other downstream useful tasks. AI model inference uses the learned parameters of the trained AI model to interpret new and previously unseen data and generate meaningful outputs.

External processing system 180 may include processing circuitry 190, which may be any of the types of processors described above for processing circuitry 110. Processing circuitry 190 may include a BEV unit 194 configured to perform the same processes as BEV unit 140. Processing circuitry 190 may acquire sensor inputs and/or camera images from camera(s) 104, respectively, or from memory 160. Though not shown, external processing system 180 may also include a memory that may be configured to store sensor inputs, camera images, model outputs, among other data that may be used in data processing. BEV unit 194 may be configured to perform any of the techniques described as being performed by BEV unit 140. Control unit 196 may be configured to perform any of the techniques described as being performed by control unit 142 including implicit depth estimation operations and regularizing loss calculation operations.

FIG. 2 depicts a flow diagram for generating updated parameters 299 to be applied using back-propagation 240, in accordance with one or more techniques of this disclosure. The functions of the flow diagram of FIG. 2 may be implemented using regularizing loss calculating unit 144, 198 and BEV units 140, 194 of FIG. 1 and/or architecture 200 of FIG. 2.

As depicted by FIG. 2, image data 202 is provided as input into an image view network 203. Camera features generated or extracted by image view network 203 may be provided as input into view transformation block 210. View transformation block 210 may be referred to as a first AI model. View transformation block 210 performs view transform operations. For instance, view transformation block 210 may convert data from the real world, as represented by extracted camera image features extracted by image view network 203, into something that can be used by processing system 100 for downstream computer vision operations (e.g., a BEV representation). The specific techniques used for view transform operations depend on the particular application and the characteristics of the input data (e.g., sensor input, images, video frames, depth maps, etc.). View transformation block 210 may perform data pre-processing enabling subsequent computer vision algorithms to operate effectively and accurately.

As depicted here, view transform block 210 includes projection unit 212 to project image features into real-world coordinates and implicit depth estimation unit 214 to generate depth probability distributions 217 as output. Projection, as applied by projection unit 212, refers to the process of transforming 2-dimensional (2D) information into a 3-dimensional (3D) representation using depth probability distributions generated by implicit depth estimation unit 214. The 2D representation may subsequently be used for rendering 2D scenes onto a 2D display, performing geometric transformations, and estimating depth relationships in images. For instance, the 2D representation may be utilized by view transform block 210 to generate depth probability distributions 217.

Example view transform operations performed by view transform block 210 may include geometric transformation, color space transformation, projection and warping, normalization and standardization, depth and 3D reconstruction, and image enhancement. In the context of computer vision for an ADAS type system, view transform block 210 may perform depth perception and/or 3D reconstruction from images utilizing, for example, like stereo vision, structure-from-motion, etc., derive depth or reconstruct 3D geometry from 2D images. Projection unit 212 may perform view transform operations including mapping and aligning virtual objects with a real-world scene or environment from the perspective of an image source, such as cameras 104 of a vehicle. In one example, a depth vector is utilized having components or bins with values which indicate the probability of an object or feature being at a depth corresponding to the component or bin. For example, a depth vector with an example quantity of 128 bins has 128 discretized depth regions from a closest to a furthest distance with values corresponding to a probability of an object being located at each bin. Different length depth vectors may be utilized. A context vector may be utilized to create, for each pixel, a number of parameters that relate to a context or attention.

View transform block 210 may perform “lift” and “splat” operations from among view transform operations sometimes referred to collectively as Lift, Splat, Shoot (LSS). The “lift” operation involves projecting from 2D (image) to 3D (world) space, whereas the “splat” operation includes reducing and/or pooling the lifted information from 3D (world) space into the 2D BEV space. The “shoot” operation relates to motion planning, as one specific application for BEV models, however, the “shoot” operation is not needed to determine the losses 225 and 285.

In accordance with at least one example, processing circuitry 110 (see FIG. 1) may be configured to perform operations utilizing implicit depth estimation unit 214 for each pixel location of the image data derived from image data 202 and projected into a BEV image space.

Output from view transform block 210 is provided into BEV grid network 230 providing a model BEV representation 215 of the real-world. BEV grid network 230 refers to a specific type of neural network architecture designed for tasks involving top-down or overhead views of environments, hence the term “Bird's-Eye-View,” especially in the context of ADAS type systems, autonomous driving, and robotics. BEV grid network 230 is a type of a neural network that takes a BEV image as input and performs computer vision tasks. For instance, BEV grid network 230 may be configured to perform computer vision tasks including perception, object detection, image segmentation, pose detection, object velocity determination, localization, mapping, navigation, and decision-making processes to enable safe and efficient operation of autonomous vehicles and robots in complex environments. BEV grid network 230 may be configured to receive as input, BEV representation 215 and provide various types of output, such as occupancy (whether the space is occupied by an obstacle or not), semantic labels (like road, sidewalk, vehicles), estimated depth, or other relevant BEV features.

BEV grid network 230 architecture is designed to process and analyze the modeled BEV representation 215 efficiently utilizing convolutional neural networks (CNNs) or similar architectures optimized for spatial processing and feature extraction from grid-like data structures. BEV grid network 230 may enable the detection and localization of objects (such as vehicles, pedestrians) in autonomous driving scenarios. The grid-based representation allows for efficient spatial and contextual interpretation of the extracted camera features projected into the BEV representation 215. In certain examples, BEV grid network 230 may perform semantic segmentation tasks to label each grid cell with its corresponding semantic class (e.g., road, sidewalk, building), associate an estimated depth, or map other extracted feature information from the BEV image space on a per-pixel or per-cell location basis. BEV grid network 230 may enable improved path planning in the context of autonomous driving and robotics, by providing a clear representation of obstacles and navigable spaces from a top-down BEV perspective.

BEV grid network 230 generates predictions as output 231 for use with downstream computer vision operations, such as vehicle assistance tasks performed by an ADAS system, autonomous driving, etc.

During training, processing system 100 may determine model loss 285 for BEV grid network 230 using output 231 and ground truth 281 information from training data 280. For instance, training may include using a loss function that measures the discrepancy between output 231 and ground truth 281 image data. Model loss 285 guides the learning process, training an encoder of a trained AI model to capture meaningful features and training a decoder of a trained AI model to produce accurate reconstructions. The training process for a trained AI model may involve minimizing the difference between a generated image provided as output 231 and ground truth 281 for a corresponding image from training data 280, e.g., using backpropagation and gradient descent techniques. Trained AI models may be trained using training data 170 from (see FIG. 1).

In accordance with the techniques of this disclosure, depth probability distributions 217 may be provided to regularizing loss calculating unit 220 which applies regularizing loss function 224 to depth probability distributions 217 to calculate loss 225. For instance, as shown here, regularization loss function 224 may be applied to a depth tensor to determine loss 225. Regularization loss function 224 may be designed based on physics constraints or physics-based assumptions. In the context of computer vision, a depth tensor refers to a multidimensional array (tensor) that stores depth information for each pixel, location, or other element of image data 202. Depth information typically represents the distance from a source (e.g., a camera) to objects in a scene, providing spatial information useful for various computer vision tasks. Note that loss 225 representing depth estimate losses is distinct from model loss 285 and may be used during training to iteratively generate updated parameters 299 for the various AI networks, for instance, to train view transform block 210 (e.g., the first AI model) to generate smoother depth probability distributions using updated parameters 299.

Calculation of model loss 285 refers to calculating a numerical value metric quantifying how well each of the models (e.g., image view network 203, view transform block 210, and BEV grid network 230) are performing with respect to a given task, such as estimating depth to objects within BEV representation 215 when compared with ground truth 281 information provided by training data 280. Model loss 285 is a measure of the difference between the predictions output 231 by BEV grid network 230 and actual ground truth 281 values (labels) in the training data 280 or validation data.

Distinct from model loss 285, regularizing loss function 224 may calculate loss 225 entirely without reference to any ground truth data by substituting physics constraints or incorporating physics-based assumptions, such as the assumption that depth probability distribution 217 should smoothly rise to a peak and fall to a baseline without excessive variability between discretized depth locations within depth probability distribution 217. As described above, view transform block 210 generates BEV representation 215 having both BEV features and depth probability distributions 217. Regularizing loss calculating unit 220 of architecture 200 calculates depth loss 225 for depth probability distribution 217 by applying regularizing loss function 224 to generate depth loss 225 as another output distinct from output 231 generated by BEV grid network 230.

Depth loss 225 may be calculated for tasks related to depth estimation from image data 202, camera images, video frames, etc. The term depth loss refers to a type of loss function used to train AI models to predict accurate depth maps or depth information, including predicting the distance of objects within a scene from the viewpoint or source of image data 202.

According to aspects of the disclosure, loss 225 is calculated entirely without reference to any ground truth information whereas model loss 285 is calculated using both output 231 and ground truth 281.

Subsequent to generation of BEV representation 215 by view transform block 210, architecture 200 may calculate depth loss 225 using regularizing loss function 224 first, followed by calculation of model loss 285 based on ground truth 281 information and output 221 from BEV grid network 230 or alternatively, architecture 200 may calculate model loss 285 first followed by calculating depth loss 225 using regularizing loss function 224. In other examples, architecture 200 may calculate both losses in parallel.

Having determined both model loss 285 and depth estimate loss 225, back-propagation 240 utilizes both model loss 285 and depth estimate loss 225 to provide updated parameters 299 for the various AI networks. For instance, during training, back-propagation 240 may be applied iteratively over multiple training epochs to update view transform block 210 (e.g., the first AI model) and/or update BEV grid network 230 (e.g., the second AI model). Back propagation 240 may provide updated parameters 299 to view transform block 210, image view network 203, BEV grid network 230, or some combination thereof.

In some examples, architecture 200 may apply back-propagation 240 iteratively to train AI model 210 and to create an updated variant of view transform block 210 (e.g., an updated variant of the first AI model). For instance, architecture 200 may apply back-propagation 240 until view transform block 210 reaches convergence, such as by satisfying an accuracy threshold for estimating depth, satisfying a threshold value for the first or second losses calculated during each of multiple training epochs, satisfying a total variation threshold for depth probability distributions 217 generated during each of the multiple training epochs, etc.

According to a particular example, application of regularization loss function 224 includes calculating differences between one or more pairs of adjacent depth values within depth probability distributions 217 generated using view transform block 210 and calculating a square of the differences between the one or more pairs of the adjacent depth values. Updated parameters 299 may be determined based on losses 225 calculated by regularization loss function 224 and model loss 285 and provided to view transform block 210 by applying back-propagation 240 to train view transform block 210 to decrease variability of depth probability distributions 217 based on the square of the differences calculated for the one or more pairs of the adjacent depth values.

According to an alternative example, application of regularization loss function 224 includes determining loss 225 by fitting a Gaussian curve to at least one of the depth probability distributions 217 to generate a normalized depth probability distribution. In such an example, regularizing loss calculating unit 220 calculates loss 225 using the normalized depth probability distribution.

According to another example, architecture 200 may apply regularizing loss function 224 to determine loss 225 from depth probability distributions 217, with such a loss 225 being utilized in subsequent training epochs to update parameters of view transform block 210.

During training, machine learning algorithms learn the characteristics of feature vectors derived from image data 202 allowing trained models to subsequently generate characteristics and features from new feature vectors derived from new image data 202 obtained at inference time (e.g., such as while operating a vehicle equipped with an ADAS type processing system 100) based on generalizations learned during model training. Feature extraction techniques performed by image view network 203 may utilize information within image data 202 or feature vectors derived from image data 202 such as raw pixel values, mean pixel values across channels, edge detection, pixel intensity, pixel depth information, and so forth, through the application of computer vision processing. Some image data 202 may be obtained as sensor input(s) including, for example, as LiDAR and/or RADAR, which may include depth information whereas other feature vectors derived from image data 202 may be void of depth information or provide inaccurate or incomplete depth information.

Feature vectors may be derived from image data 202. Image data 202 may include sensor inputs and/or camera images 168 of FIG. 1. Camera images 168 may include one or more camera images that are not present in image data 202. In some examples, image data 202 may be received from multiple cameras at different locations and/or different fields of view, which may be overlapping. In some examples, architecture 200 processes image data 202 in real-time or near real-time so that as camera(s) 104 captures feature vectors from image data 202, architecture 200 processes the feature vectors derived from image data 202. In some examples, image data 202 may represent one or more perspective views of one or more objects within a 3D space where processing system 100 is located. That is, the one or more perspective views may represent views from the perspective of processing system 100.

Architecture 200 may transform feature vectors derived from image data 202 into BEV representation 215 having BEV features and depth probability distributions 217 that represent one or more objects within a 3D environment. For instance, a view transform operation applied by view transform block 210 may consume feature vectors provided by image view network 203 to produce a BEV image from a perspective looking down at the one or more objects from a position above the one or more objects. BEV grid network 230 (e.g., a second AI model) to generate predictions as output 231. Output 231 may include, by way of example, object detection, object segmentation, displaying detected objects in a BEV format, providing a list of detected objects with their locations and predicted paths to another downstream function, lane markers identification, displaying an area around a vehicle in a Bird's-Eye-View to back-up camera display, and so forth.

Since architecture 200 may be part of an ADAS for controlling a vehicle, and since vehicles move generally across the ground in a way that is observable from a BEV perspective, generating BEV images from view transform operations applied by view transform block 210, subsequent to training, may allow a control unit (e.g., control unit 142 and/or control unit 196) of FIG. 1 to control the vehicle based on the representation of the one or more objects from a bird's eye perspective based on predictions generated utilizing an updated and trained variant of view transform block 210 (e.g., the first AI model having been updated utilizing updated parameters 299).

Architecture 200 is not limited to generating a trained and updated variant of view transform block 210 for controlling a vehicle. Architecture 200 may generate updated variants of view transform block 210 for controlling another object such as a robotic arm and/or perform one or more other tasks involving image segmentation, depth detection, object detection, or any combination thereof.

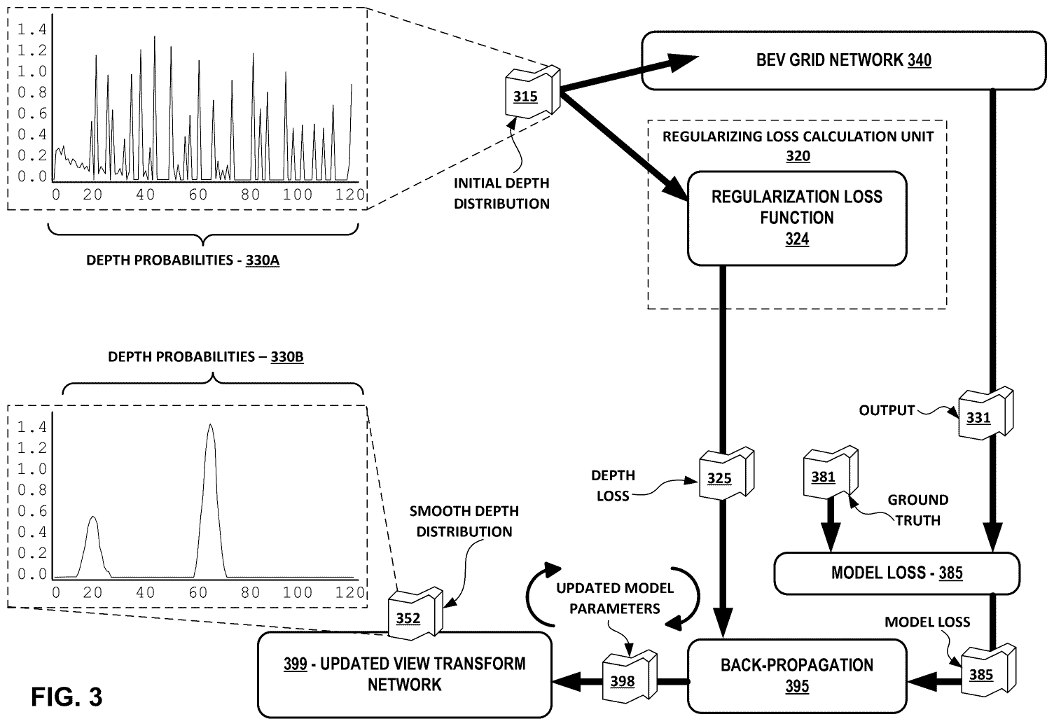

FIG. 3 is a flow diagram for back-propagating updated model parameters 398 to an updated view transform network 399, in accordance with one or more techniques of this disclosure. The functions of the flow diagram of FIG. 3 may be implemented using regularizing loss calculating unit 144, 198 and BEV units 140, 194 of FIG. 1, architecture 200 of FIG. 2, or some combination thereof.

FIG. 3 depicts an initial depth distribution 315 within which depth probabilities 330A are depicted. While the data looks chaotic due to high variability, initial depth distribution 315 may nevertheless be satisfactory to predict depths using depth probabilities 330A after having reached convergence for a test dataset. However, over-fitting may be present within an initially trained view transform network having produced the initial depth distribution which consequently may result in poor generalization to unseen test data and new information domains, especially real-world data gathered in-situ during inference of the view transform network.

According to such an example, initial depth distribution 315 is provided to each of BEV grid network 340 and regularizing loss calculating unit 320. For example, BEV grid network 340 may receive initial depth distribution 315 within a BEV representation (see FIG. 3) from a view transform block 310 along with other BEV features extracted from input images and/or sensor inputs.

Regularizing loss calculating unit 320 calculates depth loss 325 for initial depth distribution 315 using regularizing loss function 324 and provides depth loss 325 to back-propagation 395 unit. Processing system 100 may also determine model loss 385 using output 331 from BEV grid network 332 and ground truth 381 information, with model loss 385 being provided to back-propagation 395 unit along with depth loss 325. Note that depth loss 325 and model loss 385 are distinct losses, each determined and/or calculated separately.

Back-propagation 395 unit iteratively provides updated model parameters 398 to updated view transform network 399 over multiple training epochs. For instance, updated view transform network 399 may be trained to reach convergence upon the ability to generate smooth depth distribution 352 based on the iterative training applied by back-propagation 395 unit. Depth probabilities 330B are again depicted, however, the distribution of depth probabilities 330B are smoother, as indicated by the smoothly rising and falling peaks.

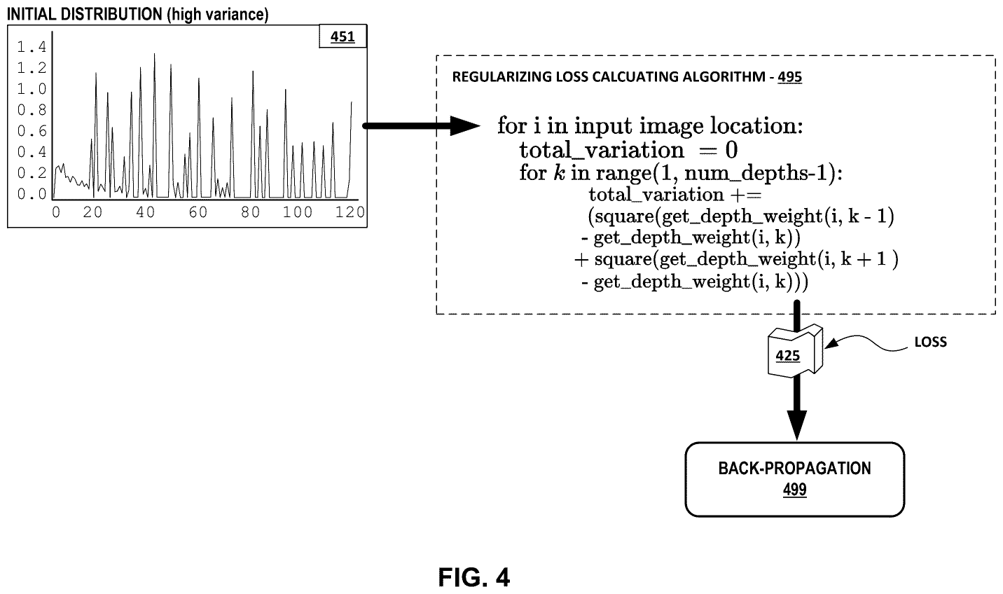

FIG. 4 provides an example of regularizing loss calculating algorithm 495, in accordance with one or more techniques of this disclosure. Regularizing loss calculating algorithm 495 of FIG. 4 may be implemented using regularizing loss calculating unit 144, 198 and BEV units 140, 194 of FIG. 1, regularizing loss function 224 of FIG. 2, regularizing loss function 324 of FIG. 3, or some combination thereof.

FIG. 4 again depicts initial distribution 451 having high variance, possibly due to noise in the training data, overfitting to the training data, a lack of sufficient ground truth information provided during training, lack of exposure to varied information domains, or some combination of factors. Additionally depicted is regularizing loss calculating operation 495 which may be applied during training to guide the depth estimation of a trained AI model toward being smoother.

Regularizing loss calculating algorithm 495 may be applied to a depth estimate distribution to generate a loss 425 which is used to update parameters of the various AI models using back-propagation 499. For instance, the updated parameters derived based on loss 425 may be utilized to generate an updated variant of view transformation block 210 (e.g., first AI model) for use during inference. The updated variant of view transformation block 210 may be trained to provide improved generalization at inference to unseen data and new information domains due to the reduction of noise and variability from the estimated depth distributions, thus permitting downstream tasks to operate more efficiently or generate predictive output with greater accuracy.

According to aspects of the techniques of the disclosure, regularizing loss calculating algorithm 495 calculates loss 425 for depth probability distributions 217 (see FIG. 2) provided by view transform block 210. For example, regularizing loss calculating algorithm 495 may include: for each element, i, of one or more sensor inputs (e.g., for each pixel, location, or other element within image data 202 of FIG. 2), regularizing loss calculating algorithm 495 initializes total variation to zero (e.g., as represented by the term “total_variation=0”) and then performs further operations for each discretized depth, k, in the depth probability distributions in a range (1 to a quantity of discretized depths, −1). Stated differently, for the range of depths ranging from 1 to the penultimate depth (e.g., every depth other than the last one), regularizing loss calculating algorithm 495 further performs for, k, operations including: adding to the total variation, a first sum of a square of differences for the respective element, i, using a previous depth (i, k−1) in the depth probability distributions with a current depth, (i, k), corresponding to the respective discretized depth, and adding to the total variation, a second sum of the square of the differences for the current depth, (i, k), corresponding to the respective discretized depth compared with a next depth (i, k+1) in the depth probability distributions.

According to such an example, regularizing loss calculating algorithm 495 further accumulates the total variation for each discretized depth, k, for each element, i, as loss 225 (see FIG. 2). Model loss 285 of FIG. 2 is calculated separately based on output 231 and ground truth 281.

According to at least one example, regularizing loss calculating algorithm 495 may be configured to yield a higher loss when the fitted Gaussian model satisfies a large variance threshold (e.g. a large spread over distances). According to another example, regularizing loss calculating algorithm 495 fits a gaussian mixture model (GMM), formed as a combination of multiple gaussian models, corresponding to multiple correct peaks (e.g., distances) in the depth distribution curve. For instance, regularizing loss calculating algorithm 495 may utilize a GMM to evaluate whether a ray intersecting a specific part of an image collides with one or more other objects at different distances.

With reference to FIG. 2 and regularizing loss calculating algorithm 495 of FIG. 4, according to certain aspects of the disclosure, the accumulated total variation utilized as loss 225 may additionally be weighted prior to applying back-propagation 240 to provide the various AI models with the updated parameters 299. For instance, the calculated term “total_variation” (e.g., loss 225, 325, or 425) may be weighted by a configurable loss weight and added to the separately calculated model loss 285 to determine a weighted combination of loss 225 and loss 285. According to such an example, the various AI models are provided with updated parameters 299 based at least in part on the weighted combination of the first loss and the second loss (e.g., loss 225 and loss 285) by applying back-propagation 240 to update the parameters of the various AI models (e.g., to update at least view transform block 210).

According to such an example, regularizing loss calculating algorithm 495 is differentiable and helps to guide implicit depth estimation 214 (see FIG. 2) to be locally smoother along the depth axis for each discretized location in image data 202.

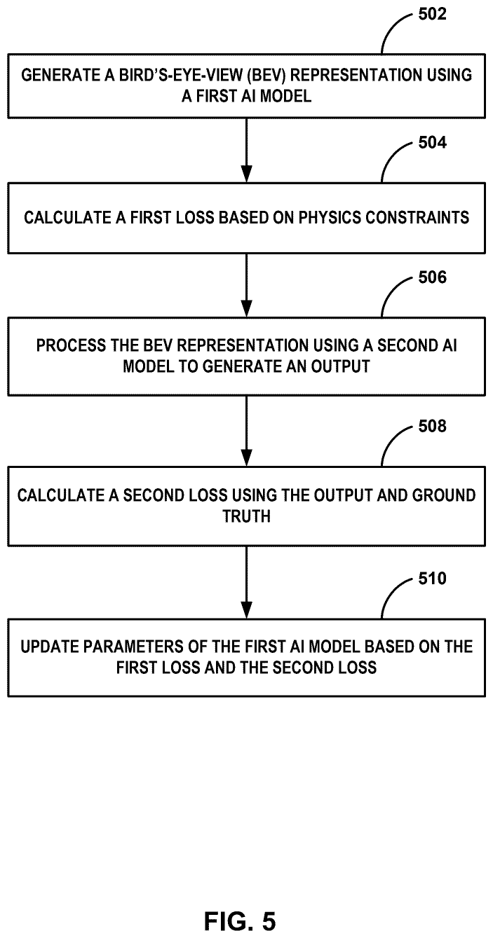

FIG. 5 is a flow diagram illustrating an example method for training perception models substituting a regularizing loss function for depth ground truth. FIG. 5 is described with respect to processing system 100 and external processing system 180 of FIG. 1, architecture 200 of FIG. 2, and the methods discussed in FIGS. 3 and 4. However, the techniques of FIG. 5 may be performed by different components of processing system 100, external processing system 180, architecture 200, or by additional or alternative systems.

Processing circuitry 110 may be configured to generate Bird's-Eye-View (BEV) representation 215 using a view transform block 210 (e.g., a first AI model) (502). For instance, processing circuitry 110 may generate, using a first AI model, BEV representation 215 from one or more feature vectors derived from image data 202, in which BEV representation 215 includes BEV features and depth probability distributions 217.

According to such an example, processing circuitry 110 may be configured to calculate a first loss (e.g., depth loss 205) using regularizing loss function 224 (504). Continuing with such an example, processing circuitry 110 may be configured to process, using BEV grid network 230 (e.g., a second AI mode), BEV representation 215 to generate output 231 (506). Processing circuitry may also be configured to calculate a second loss (model loss 285) using output 221 and ground truth 281 (506). In some examples, processing circuitry 110 is configured to update parameters (e.g., updated parameters 299) of view transform block 210 (e.g., the first AI model) based on the first loss (depth loss 225) and the second loss (model loss 285) (508). For instance, processing circuitry 110 may be configured to apply back-propagation 240 to generate updated parameters 299 for the various AI networks. For instance, view transform block 210 (e.g., first AI model) may be iteratively updated using updated parameters 299 over the course of multiple training epochs to create an updated variant of view transform block 210 for use at inference time.

Additional aspects of the disclosure are detailed in numbered clauses below.
Clause 1—An apparatus for training a neural network, the apparatus comprising: a memory; and processing circuitry in communication with the memory, wherein the processing circuitry is configured to: generate, using a first AI model, a birds-eye-view (BEV) representation from one or more sensor inputs, the BEV representation including BEV features and depth probability distributions; calculate a first loss for the depth probability distributions using a regularizing loss function; process, using a second AI model, the BEV representation to generate an output; calculate a second loss using the output and ground truth; and update parameters of the first AI model based on the first loss and the second loss.
Clause 2—The apparatus of clause 1, wherein to calculate the first loss, the processing circuitry is configured to: calculate the first loss based on a sum of a square of differences of adjacent depth values from the depth probability distributions; and wherein to update the parameters of the first AI model based on the first loss and the second loss the processing circuitry is further configured to train the first AI model using back-propagation.
Clause 3—The apparatus of any of clauses 1-2, wherein the processing circuitry is further configured to: calculate a weighted combination of the first loss and the second loss; and wherein to update the parameters of the first AI model based on the first loss and the second loss, the processing circuitry is further configured to apply back-propagation to update the parameters of the first AI model using the weighted combination of the first loss and the second loss.
Clause 4—The apparatus of any of clauses 1-3, wherein the processing circuitry is further configured to: fit a Gaussian curve to at least one of the depth probability distributions to generate a normalized depth probability distribution; and wherein to calculate the first loss for the depth probability distributions the processing circuitry is further configured to calculate the first loss using the normalized depth probability distribution.
Clause 5—The apparatus of any of clauses 1-4, wherein to calculate the first loss for the depth probability distributions using the regularizing loss function the processing circuitry is further configured to calculate the first loss for the depth probability distributions without using depth ground truth.
Clause 6—The apparatus of any of clauses 1-5, wherein the processing circuitry is configured to: obtain the one or more sensor inputs; and wherein the one or more sensor inputs comprise at least one of: one or more camera images; one or more frames of video data; Light Detection and Ranging (LiDAR) data; or Radio Detection and Ranging (RADAR) data.
Clause 7—The apparatus of any of clauses 1-6, wherein the processing circuitry is configured to: generate an updated first AI model using the parameters of the first AI model updated based on the first loss and the second loss; generate, using the updated first AI model, new BEV representations from one or more new sensor inputs captured by one or more sensors of a vehicle; and process the new BEV representations to control the vehicle.
Clause 8—The apparatus of any of clauses 1-7, wherein to update the parameters of the first AI model based on the first loss and the second loss the processing circuitry configured is further configured to iteratively calculate the first loss and the second loss and update the parameters of the first AI model based on the first loss and the second loss for multiple epochs to generate an updated first AI model; and wherein the processing circuitry is configured to utilize the updated first AI model to control a vehicle.
Clause 9—The apparatus of any of clauses 1-8, wherein to calculate the first loss for the depth probability distributions using the regularizing loss function the processing circuitry is further configured to: for each element, i, of the one or more sensor inputs: initializing total variation to zero; for each discretized depth, k, in the depth probability distributions in a range (1 to a quantity of discretized depths, −1): adding to the total variation, a first sum of a square of differences for the respective element, i, using a previous depth (i, k−1) in the depth probability distributions with a current depth, (i, k), corresponding to the respective discretized depth, and adding to the total variation, a second sum of the square of the differences for the current depth, (i, k), corresponding to the respective discretized depth compared with a next depth (i, k+1) in the depth probability distributions; and accumulating the total variation for each discretized depth, k, for each element, i, as the first loss.
Clause 10—A method of training a neural network, the method comprising: generating, using a first AI model, a birds-eye-view (BEV) representation from one or more sensor inputs, the BEV representation including BEV features and depth probability distributions; calculating a first loss for the depth probability distributions using a regularizing loss function; processing, using a second AI model, the BEV representation to generate an output; calculating a second loss using the output and ground truth; and updating parameters of the first AI model based on the first loss and the second loss.
Clause 11—The method of clause 10, wherein calculating the first loss includes calculating the first loss based on a sum of a square of differences of adjacent depth values from the depth probability distributions; and wherein updating the parameters of the first AI model based on the first loss and the second loss includes training the first AI model using back-propagation.
Clause 12—The method of any of clauses 10-11, further comprising: calculating a weighted combination of the first loss and the second loss; and wherein updating the parameters of the first AI model based on the first loss and the second loss, includes applying back-propagation to update the parameters of the first AI model using the weighted combination of the first loss and the second loss.
Clause 13—The method of any of clauses 10-12, further comprising: fitting a Gaussian curve to at least one of the depth probability distributions to generate a normalized depth probability distribution; and wherein calculating the first loss for the depth probability distributions includes calculating the first loss using the normalized depth probability distribution.
Clause 14—The method of any of clauses 10-13, wherein calculating the first loss for the depth probability distributions using the regularizing loss function includes calculating the first loss for the depth probability distributions without using depth ground truth.
Clause 15—The method of any of clauses 10-14, further comprising: obtaining the one or more sensor inputs; and wherein the one or more sensor inputs comprise at least one of: one or more camera images; one or more frames of video data; Light Detection and Ranging (LiDAR) data; or Radio Detection and Ranging (RADAR) data.
Clause 16—The method of any of clauses 10-15, further comprising: generating an updated first AI model using the parameters of the first AI model updated based on the first loss and the second loss; generating, using the updated first AI model, new BEV representations from one or more new sensor inputs captured by one or more sensors of a vehicle; and processing the new BEV representations to control the vehicle.
Clause 17—The method of any of clauses 10-16, wherein updating the parameters of the first AI model based on the first loss and the second loss includes iteratively calculating the first loss and the second loss and updating the parameters of the first AI model based on the first loss and the second loss for multiple epochs to generate an updated first AI model; and wherein the method further includes utilizing the updated first AI model to control a vehicle.
Clause 18—The method of any of clauses 10-17, wherein calculating the first loss for the depth probability distributions using the regularizing loss function, includes: for each element, i, of the one or more sensor inputs: initializing total variation to zero; for each discretized depth, k, in the depth probability distributions in a range (1 to a quantity of discretized depths, −1): adding to the total variation, a first sum of a square of differences for the respective element, i, using a previous depth (i, k−1) in the depth probability distributions with a current depth, (i, k), corresponding to the respective discretized depth, and adding to the total variation, a second sum of the square of the differences for the current depth, (i, k), corresponding to the respective discretized depth compared with a next depth (i, k+1) in the depth probability distributions; and accumulating the total variation for each discretized depth, k, for each element, i, as the first loss.
Clause 19—A method of performing a vehicle assistance task, the method comprising: receiving one or more sensor inputs from a vehicle; generating, using a first AI model, a birds-eye-view (BEV) representation from the one or more sensor inputs, the BEV representation including BEV features and depth probability distributions, the first AI model having been trained based on a calculation of a loss for the depth probability distributions using a regularizing loss function; and while the vehicle is in operation, performing the vehicle assistant task based on the BEV.
Clause 20—The method of clause 19: wherein the vehicle includes an advanced driver-assistance system (ADAS) to at least partially control operation of the vehicle; and wherein the method further comprises: receiving one or more new sensor inputs from the vehicle; generating, using the first AI model, new BEV representations from the one or more new sensor inputs captured by one or more sensors of the vehicle; and processing the new BEV representations using the ADAS to control the vehicle.
Clause 21—An apparatus comprising means for performing any combination of techniques of clauses 10-20.

It is to be recognized that depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and applied by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be applied by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for training a neural network, the apparatus comprising:
a memory; and
processing circuitry in communication with the memory, wherein the processing circuitry is configured to:
generate, using a first AI model, a birds-eye-view (BEV) representation from one or more sensor inputs, the BEV representation including BEV features and depth probability distributions;
calculate a first loss for the depth probability distributions using a regularizing loss function;
process, using a second AI model, the BEV representation to generate an output;
calculate a second loss using the output and ground truth; and
update parameters of the first AI model based on the first loss and the second loss.

2. The apparatus of claim 1, wherein to calculate the first loss, the processing circuitry is configured to:
calculate the first loss based on a sum of a square of differences of adjacent depth values from the depth probability distributions; and
wherein to update the parameters of the first AI model based on the first loss and the second loss the processing circuitry is further configured to train the first AI model using back-propagation.

3. The apparatus of claim 1, wherein the processing circuitry is further configured to:
calculate a weighted combination of the first loss and the second loss; and
wherein to update the parameters of the first AI model based on the first loss and the second loss, the processing circuitry is further configured to apply back-propagation to update the parameters of the first AI model using the weighted combination of the first loss and the second loss.

4. The apparatus of claim 1, wherein the processing circuitry is further configured to:
fit a Gaussian curve to at least one of the depth probability distributions to generate a normalized depth probability distribution; and
wherein to calculate the first loss for the depth probability distributions the processing circuitry is further configured to calculate the first loss using the normalized depth probability distribution.

5. The apparatus of claim 1, wherein to calculate the first loss for the depth probability distributions using the regularizing loss function the processing circuitry is further configured to calculate the first loss for the depth probability distributions without using depth ground truth.

6. The apparatus of claim 1, wherein the processing circuitry is configured to:
obtain the one or more sensor inputs; and
wherein the one or more sensor inputs comprise at least one of:
one or more camera images;
one or more frames of video data;
Light Detection and Ranging (LiDAR) data; or
Radio Detection and Ranging (RADAR) data.

7. The apparatus of claim 1, wherein the processing circuitry is configured to:
generate an updated first AI model using the parameters of the first AI model updated based on the first loss and the second loss;
generate, using the updated first AI model, new BEV representations from one or more new sensor inputs captured by one or more sensors of a vehicle; and
process the new BEV representations to control the vehicle.

8. The apparatus of claim 1:
wherein to update the parameters of the first AI model based on the first loss and the second loss the processing circuitry configured is further configured to iteratively calculate the first loss and the second loss and update the parameters of the first AI model based on the first loss and the second loss for multiple epochs to generate an updated first AI model; and
wherein the processing circuitry is configured to utilize the updated first AI model to control a vehicle.

9. The apparatus of claim 1, wherein to calculate the first loss for the depth probability distributions using the regularizing loss function the processing circuitry is further configured to:
for each element, i, of the one or more sensor inputs:
initializing total variation to zero;
for each discretized depth, k, in the depth probability distributions in a range (1 to a quantity of discretized depths, −1):
adding to the total variation, a first sum of a square of differences for the respective element, i, using a previous depth (i, k−1) in the depth probability distributions with a current depth, (i, k), corresponding to the respective discretized depth, and
adding to the total variation, a second sum of the square of the differences for the current depth, (i, k), corresponding to the respective discretized depth compared with a next depth (i, k+1) in the depth probability distributions; and
accumulating the total variation for each discretized depth, k, for each element, i, as the first loss.

10. A method of training a neural network, the method comprising:
generating, using a first AI model, a birds-eye-view (BEV) representation from one or more sensor inputs, the BEV representation including BEV features and depth probability distributions;
calculating a first loss for the depth probability distributions using a regularizing loss function;
processing, using a second AI model, the BEV representation to generate an output;
calculating a second loss using the output and ground truth; and
updating parameters of the first AI model based on the first loss and the second loss.

11. The method of claim 10:
wherein calculating the first loss includes calculating the first loss based on a sum of a square of differences of adjacent depth values from the depth probability distributions; and
wherein updating the parameters of the first AI model based on the first loss and the second loss includes training the first AI model using back-propagation.

12. The method of claim 10, further comprising:
calculating a weighted combination of the first loss and the second loss; and
wherein updating the parameters of the first AI model based on the first loss and the second loss, includes applying back-propagation to update the parameters of the first AI model using the weighted combination of the first loss and the second loss.

13. The method of claim 10, further comprising:
fitting a Gaussian curve to at least one of the depth probability distributions to generate a normalized depth probability distribution; and
wherein calculating the first loss for the depth probability distributions includes calculating the first loss using the normalized depth probability distribution.

14. The method of claim 10, wherein calculating the first loss for the depth probability distributions using the regularizing loss function includes calculating the first loss for the depth probability distributions without using depth ground truth.

15. The method of claim 10, further comprising:
obtaining the one or more sensor inputs; and
wherein the one or more sensor inputs comprise at least one of:
one or more camera images;
one or more frames of video data;
Light Detection and Ranging (LiDAR) data; or
Radio Detection and Ranging (RADAR) data.

16. The method of claim 10, further comprising:
generating an updated first AI model using the parameters of the first AI model updated based on the first loss and the second loss;
generating, using the updated first AI model, new BEV representations from one or more new sensor inputs captured by one or more sensors of a vehicle; and
processing the new BEV representations to control the vehicle.

17. The method of claim 10:
wherein updating the parameters of the first AI model based on the first loss and the second loss includes iteratively calculating the first loss and the second loss and updating the parameters of the first AI model based on the first loss and the second loss for multiple epochs to generate an updated first AI model; and
wherein the method further includes utilizing the updated first AI model to control a vehicle.

18. The method of claim 10, wherein calculating the first loss for the depth probability distributions using the regularizing loss function, includes:
for each element, i, of the one or more sensor inputs:
initializing total variation to zero;
for each discretized depth, k, in the depth probability distributions in a range (1 to a quantity of discretized depths, −1):
adding to the total variation, a first sum of a square of differences for the respective element, i, using a previous depth (i, k−1) in the depth probability distributions with a current depth, (i, k), corresponding to the respective discretized depth, and
adding to the total variation, a second sum of the square of the differences for the current depth, (i, k), corresponding to the respective discretized depth compared with a next depth (i, k+1) in the depth probability distributions; and
accumulating the total variation for each discretized depth, k, for each element, i, as the first loss.

19. A method of performing a vehicle assistance task, the method comprising:
receiving one or more sensor inputs from a vehicle;
generating, using a first AI model, a birds-eye-view (BEV) representation from the one or more sensor inputs, the BEV representation including BEV features and depth probability distributions,
the first AI model having been trained based on a calculation of a loss for the depth probability distributions using a regularizing loss function; and
while the vehicle is in operation, performing the vehicle assistant task based on the BEV.

20. The method of claim 19:
wherein the vehicle includes an advanced driver-assistance system (ADAS) to at least partially control operation of the vehicle; and
wherein the method further comprises:
receiving one or more new sensor inputs from the vehicle;
generating, using the first AI model, new BEV representations from the one or more new sensor inputs captured by one or more sensors of the vehicle; and
processing the new BEV representations using the ADAS to control the vehicle.
